(19) United States
(12) Patent Application Publication
(10) Pub. No.: US 2006/0139658 A1
(43) Pub. Date: Jun. 29, 2006

(54) Inspection method for warpage of rod and inspection apparatus therefor

(76) Inventors: Hisashi Uetani, Minato-ku (JP); Keisuke Tsutsui, Minato-ku (JP); Atsushi Miyake, Minato-ku (JP)

Correspondence Address: RATNERPRESTIA, P O BOX 980, VALLEY FORGE, PA, 19482-0980, US

(21) Appl. No.: 11/292,506

(22) Filed: Dec. 2, 2005

(30) Foreign Application Priority Data
Dec. 2, 2004 (JP) 2004-350,134

(51) Int. Cl. G01B 11/24

(52) U.S. Cl. 356/601

(57) ABSTRACT

There are provided a method and apparatus capable of conveniently and rapidly inspecting a warpage of a rod. A rod to be inspected is rolled down an inspection bed and light shielded by the downwardly rolling rod is detected by a line sensor as a one-dimensional image signal. A positional fluctuation value of the downwardly rolling rod is obtained from a two-dimensional image signal obtained from the one-dimensional image signal. Based on the positional fluctuation value, the degree of the warpage of the rod is determined. The shielded light signal is detected in the vicinity of one end of the downwardly rolling rod to be inspected.

### TECHNICAL FIELD

The present invention relates to an inspection method for a warpage of a rod and an inspection device therefor.

### RELATED ART

Japanese Patent Laid-Open No. H05-45139 discloses an inspection method for a round bar and an inspection apparatus therefor in which a light beam is irradiated onto a round bar on rolling, along the longitudinal direction thereof from one end thereof so as to measure a quantity of light which comes to the other end thereof in order to measure a curve of the round bar. That is, disclosed are inspection method and apparatus each of which utilizes a fact that a round bar to be inspected is rolled down on a slope so that the light beam is shielded by a warpage of the round bar on rolling on a reference surface, and, accordingly, a quantity of light coming onto a photo-detector is varied depending on a degree of the warpage.

Japanese Patent Laid-Open No. 2003-148948 discloses measurement method and apparatus in which a laser beam is irradiated onto a base material of a columnar optical fiber having a circular cross-sectional shape from a direction perpendicular to the axial direction of the optical fiber while securely holding its opposite ends, so as to measure a diametrical variation and a radial deviation of the center axis of the base material of the optical fiber, thereby measuring a curve of the base material of the optical fiber.

### DISCLOSURE OF THE INVENTION

However, the method disclosed in the Japanese Patent Laid-Open No. H05-45139 has to be implemented with the use of an optical system having a laser source, a photo-detector and accurate positioning mechanisms therefor in order to measure a curve of a rod-like object. Thus, in order to build up a production line with the use of the above-mentioned inspection apparatus, there has been caused such a problem that costs of an inspection facility become higher especially in the case of using several expensive inspection devices. Further, there has been raised another problem that measurement of a curve of a rod-like object with a high accuracy is difficult.

Moreover, although the measurement method disclosed in the Japanese Patent Laid-Open No. 2003-148948 has an advantage of precisely measuring a curve of an optical fiber, it needs a large facility and thus has a difficulty of measuring a warpage (curve) of a rod-like object in an economical and rapid manner.

The present invention is addressed to solve the above-mentioned problems, and accordingly, an object of the present invention is to provide a method capable of conveniently measuring a warpage (curve) of a rod, and an apparatus for carrying out the method.

A first aspect of the present invention is a method for inspecting a warpage of a rod, comprising the steps of rolling down a rod to be inspected on an inspection bed, detecting light shielded by the downwardly rolling rod by a line sensor as a one-dimensional image signal, obtaining a positional fluctuation value of the downwardly rolling rod from a two-dimensional image signal obtained from the one-dimensional image signal, and inspecting a warpage of the rod on the basis of the positional fluctuation value.

A second aspect of the present invention is based on the method as set forth in the first aspect, and further comprises the step of obtaining a position of gravitational center of the downwardly rolling rod from the two-dimensional image signal, and wherein the positional fluctuation value is a fluctuation value in a corrected position of gravitation center indicated as a difference between the position of gravitational center and a moving average value of the position of gravitational center.

A third aspect of the present invention is based on the method as set forth in the first or second aspect, wherein the shielded light signal is detected in the vicinity of one end of the rod to be inspected.

A fourth aspect of the present invention is an apparatus for inspecting a warpage of a rod, comprising an inspection bed for rolling down a rod to be inspected in an inclined direction; an illumination device arranged on one side in relation to a slit provided in the inclined direction of the inspection bed; a line sensor arranged on the other side in relation to the slit; an image reading means for reading a one-dimensional image signal detected by the line sensor, as a two-dimensional image signal, in accordance with light emitted from the illumination device and shielded by the downwardly rolling rod to be inspected; and a computation means for computing a positional fluctuation value of the downwardly rolling rod from the two-dimensional image signal.

A fifth aspect of the present invention is based on the apparatus as set forth in the fourth aspect, wherein the computation means carries out such a computation that a position of gravitational center of the downwardly rolling rod is obtained from the two-dimensional image signal, then, a corrected position of gravitational center of the downwardly rolling rod is obtained from a difference between the position of gravitational center and a moving average of the position of gravitational center, and thereafter, a maximum amplitude of the corrected position of gravitational center is computed.

A sixth aspect of the present invention is based on the apparatus as set forth in the fourth or fifth aspect of the present invention, further comprising a memory means for a threshold value for the maximum amplitude, and a determination means for determining whether the rod to be inspected is good or bad by comparing the maximum amplitude of the rod to be inspected with the threshold value.

A seventh aspect of the present invention is based on the apparatus as set forth in any of the fourth to sixth aspects, wherein the slit is provided at a position over which the vicinity of one end of the downwardly rolling rod to be inspected.

An eighth aspect of the present invention is based on the apparatus as set forth in any one of the fourth to seventh aspects of the present invention, wherein the illumination device is a linear light source in which LEDs are linearly arranged or a rod-like fluorescent lamp.

If a rod has a warpage or a curve, it rolls down on the inspection bed in a roll-down direction while its position is back and forth, i.e., its position fluctuates in the roll-down direction. The larger the degree of the warpage or curve of the rod is, the larger the positional fluctuation becomes. According to the method for inspecting a warpage of a rod in the first aspect of the invention, inspection of a warpage of a rod can be finished in a short time since light shielded by the downwardly rolling rod is detected by the line sensor in the form of a one-dimensional image signal, and the positional fluctuation may be instantly computed from a two-dimensional image signal which is obtained from the one-dimensional image signal.

Further, by setting the position of the downwardly rolling rod obtained from the two-dimensional image signal as a position of gravitational center of the shielded light signal so as to evaluate magnitude of the warpage from a value of fluctuation of the position of gravitational center of the shielded light signal, the relationship with the degree of the warpage may be ensured.

Further, by detecting the shielded light signal in the vicinity of one end of the rod to be inspected, the sensitivity of detection for the positional fluctuation may be enhanced, thereby reducing a detection limit of a warpage.

The inspection apparatus for inspecting a warpage of a rod according to the present invention includes a main hardware unit in which the inspection bed for rolling down a rod thereon under the gravity, the illumination device and the line sensor, and the computing means for reading the two-dimensional image signal and computing a value of positional fluctuation of the rod, so that the installation costs of the apparatus may be inexpensive. In addition, the apparatus may further include the memory means for storing therein a threshold value relating to a positional fluctuation of a non-defective rod, and the determination means for comparing the positional fluctuation value of the rod to be inspected with the threshold value so as to determine whether the rod to be inspected is good or bad. Such an apparatus may rapidly and conveniently conduct a sorting and inspection at a production job site.

### BRIEF DESCRIPTION OF THE DRAWINGS

Further object and advantages of the present as well as those as stated above, will be apparent from preferred embodiments of the present invention, which will be herein made in detail with reference to the accompanying drawings which are:

FIG. 1 is a view of explaining an arrangement of an inspection bed, an illumination apparatus and a line sensor in one embodiment of an apparatus for inspecting a warpage of a rod according to the present invention;

FIG. 2 is a view for explaining an overall configuration of the embodiment of an apparatus for inspecting a warpage of a rod according to the present invention;

FIG. 3 is a view for explaining positional data stored in an image reading means according to the present invention;

FIG. 4 is a flow-chart for explaining a method of computing a value of positional fluctuation according to the present invention;

FIG. 5 is a view for explaining a signal of light shielded by a downwardly rolling rod and detected by a line sensor 4 according to the present invention;

FIG. 6 shows data of positional fluctuation as to a sample of rods selected in a group A in a reference example 1 of the present invention;

FIG. 7 shows data of positional fluctuation as to a sample of rods selected in a group B in the reference example 1; and

FIG. 8 is a view for explaining a warpage of a rod.

### BEST MODE FOR CARRYING OUT THE INVENTION

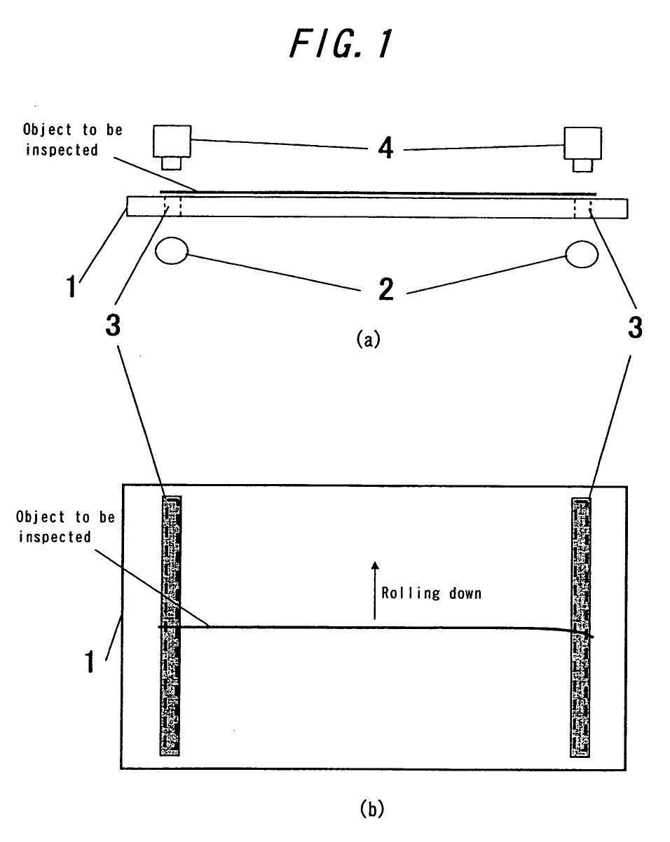

Hereinafter, explanation will be made of an embodiment of the present invention with reference to the accompanying drawings. Referring to FIG. 1, shown is an arrangement of an inspection bed, illumination devices and line sensors in an apparatus for inspecting a warpage of a rod in one embodiment of the present invention. The inspection bed 1 is provided, in the vicinity of its opposite side ends, with slits 3 having a width of about 5 mm and a length of about 120 mm. The inspection bed 1 is arranged on a reference bed (not shown) with being inclined by an angle of about 2 to 5 deg. with respect to the longitudinal direction of the slits 3. Below the slits 3, illumination devices (rod-like white fluorescent lamps or the like) 2 are laid along openings in the slits 3. Meanwhile, the line sensors 4 are laid along the upper openings of the slits 3 at positions where the line sensors 4 can receive light emitted from the fluorescent lamps 2. It is noted that the positions of the illumination devices 2 and the line sensors 4 may be reversed.

A rod to be inspected, such as a linear object or a rod-like object having a circular cross-section, is set on the inspection bed at its one end, spanning between both slits 3, and is rolled down in the direction of the arrow as shown in FIG. 1, under the gravity. The downwardly rolling rod shields light emitted from the fluorescent lamp, and accordingly, the shielded light is detected as a shielded light signal by the line sensors 4. FIG. 1 shows an embodiment in which the shielded light is detected simultaneously at two positions of the rod in the vicinity of opposite ends thereof. The above-mentioned detection may be conducted at one position of the rod in the vicinity of the opposite ends, or may be conducted at one or more positions with the use of a slit formed in the center part of the inspection bed, depending on an object of the detection.

As the position on a downwardly rolling rod, there may be used an outer peripheral surface in the roll-down direction of the rod, i.e. a position where the rod starts shielding the light, or an outer peripheral surface in a direction opposite to the roll-down direction of the rod, i.e. a position where the rod starts ending of the light shield. Further, there may be used the position of gravitational center of the rod which is calculated from a spectrum of the shielded light signal.

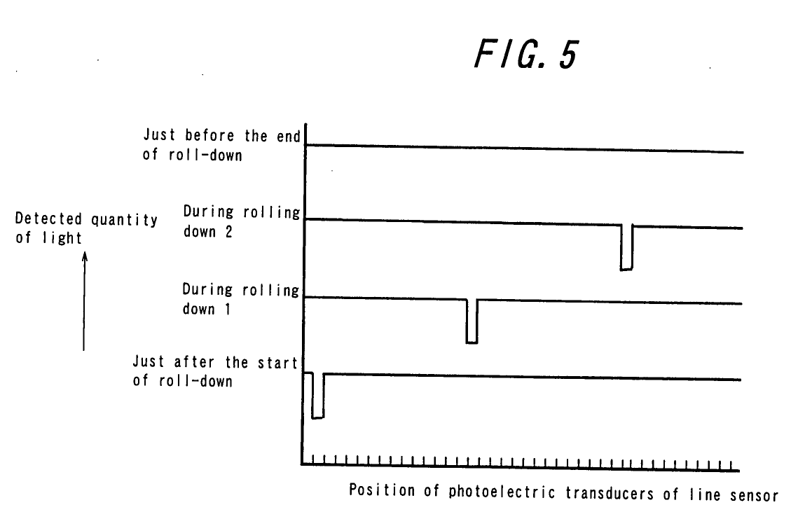

FIG. 5 shows a schematic view illustrating shielded light signals that are caused by the rod on rolling down from the time just after the start of roll-down to the time just before the end of roll-down, and that are detected by photoelectric transducers which are arranged in a row within the line sensor 4. It is shown in FIG. 5 that a shielded light signal (a substantially rectangular signal in FIG. 5) is detected when the quantity of a received light is dropped during rolling down of the rod, and that the position of a photoelectric transducer is shifted from the left to the light. According to the present invention, either of a position where the intensity of the rectangular signal is attenuated, a position where the intensity of the rectangular signal is recovered and the position of gravitational center of the rod may be used as a positional data of the rod. The position of gravitational center (which is calculated from the spectrum of the shielded light signal) is preferable since the rod position may be reliably calculated even if the line sensor has the small number of the photoelectric transducers and, therefore, the rectangular pulse of the shielded light signal collapses to give a pulse with the leading and the trailing edges being slanted.

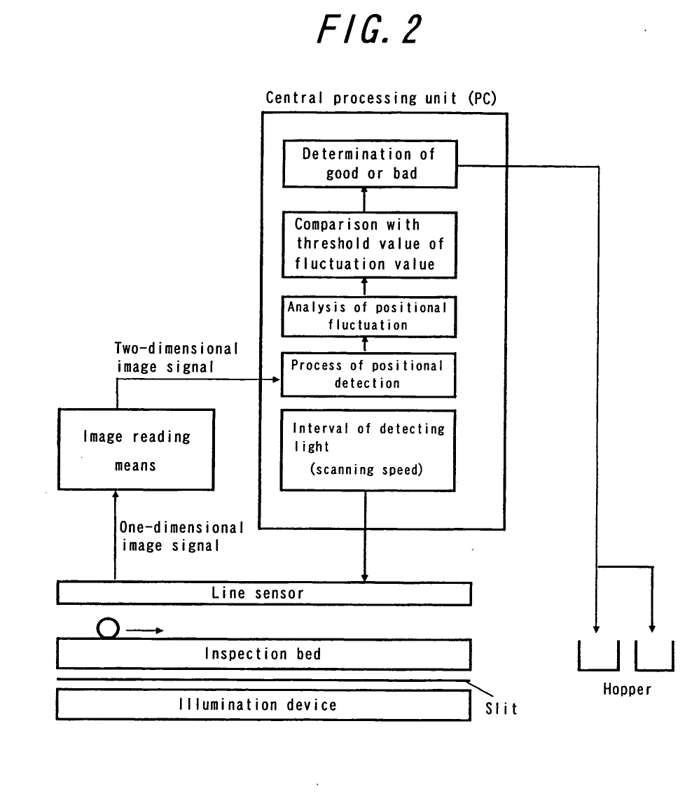

FIG. 2 is a view for explaining an overall configuration of one embodiment of the apparatus for inspecting a warpage of a rod according to the present invention. The shielded light caused by the rod which is rolled down on the inspection bed under the gravity is detected by the line sensors as a shielded light signal. As the illumination device, a linear light source including a plurality of white LEDs which are arranged in a line-like configuration is preferably used, as well as a white or daylight fluorescent lamp.

Intervals (which relate to a scanning speed of the photoelectric transducers in the line sensor) with which the light emitted from the illumination device is detected by the line sensor are transmitted from an external unit to a central computing unit incorporated in a personal computer. The number of photoelectric transducers (CCD linear sensors) in the line sensor has a relation with detecting resolution of a position as to a positional signal of the downwardly rolling rod, and, for example, a sensor having 7,450 pixels may be used. A line sensor having not less than 2,048 pixels is preferably use to ensure positional detection which may achieve an object of the present invention and to ensure the computation of a two-dimensional image signal from a thus obtained one-dimensional image signal. The detection intervals of shielded light signals is suitably set, depending upon a diameter of a rod, a roll-down speed and the like, and it is usually set to 0.2 to 1 msec. A sampling time of the shielded light signals on rolling is set to about 1 to 3 sec.

The one-dimensional image signal detected by the line sensor as the shielded light signal is stored in the image reading means including an input signal correcting circuit, an A/D converter (8 bit 256 gradation) and an image memory circuit for a digitalized signal. As to the position of the rod with which the positional detection can be made (a process of detecting a position), there may be used, as stated above, either one of the position of starting lowering of an intensity of a spectrum of a detection signal, the position of gravitational center, a position of recovery of the intensity and the like. From the thus obtained positional data, a value of positional fluctuation may be calculated as will be described hereinbelow (analysis of positional fluctuation).

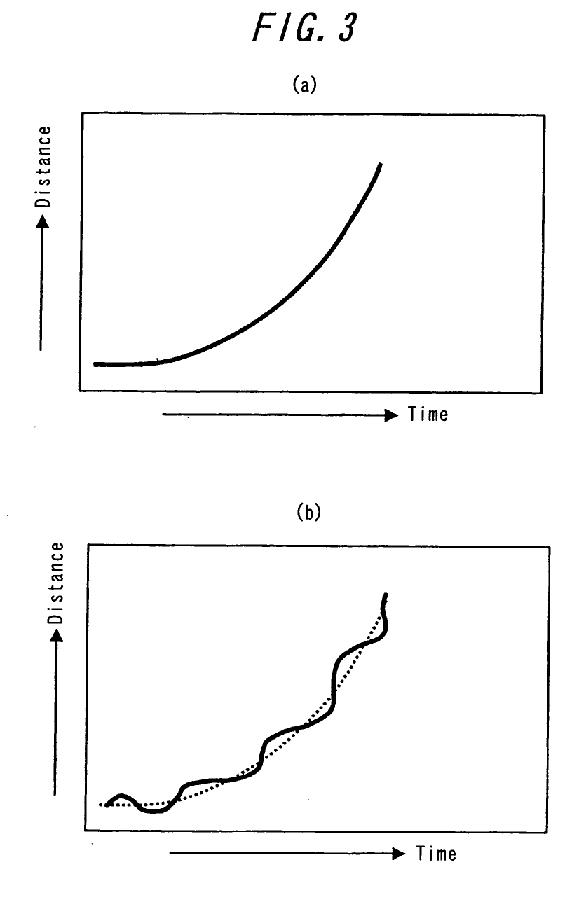

The data stored in the image reading means is positional data of a detection signal based upon the shielded light, relating to an axis of time from a start and an axis of distance (corresponding to a position of a photoelectric transducer). In the case of an ideal columnar rod-like object having no warpage, no curve, no eccentricity or the like, a smooth curve (having no positional fluctuation) as shown in FIG. 3 (a) is stored in the image reading means. Meanwhile, as shown in FIG. 3 (b), in the case of a rod having a warpage or a curve, a positional signal based upon light shielded by the rod is moved with fluctuation (moving back and forth in the roll-down direction). The dotted line in FIG. 3 (b) exhibits a moving average position curve obtained by subjecting the position curve of the rod to a moving average process, and a positional fluctuation value of the rod is obtained by a degree of deviation of the position of gravitational center from this moving average position curve. In one embodiment of the present invention as will be explained below, the positional fluctuation value is calculated with the use of the position of gravitational center.

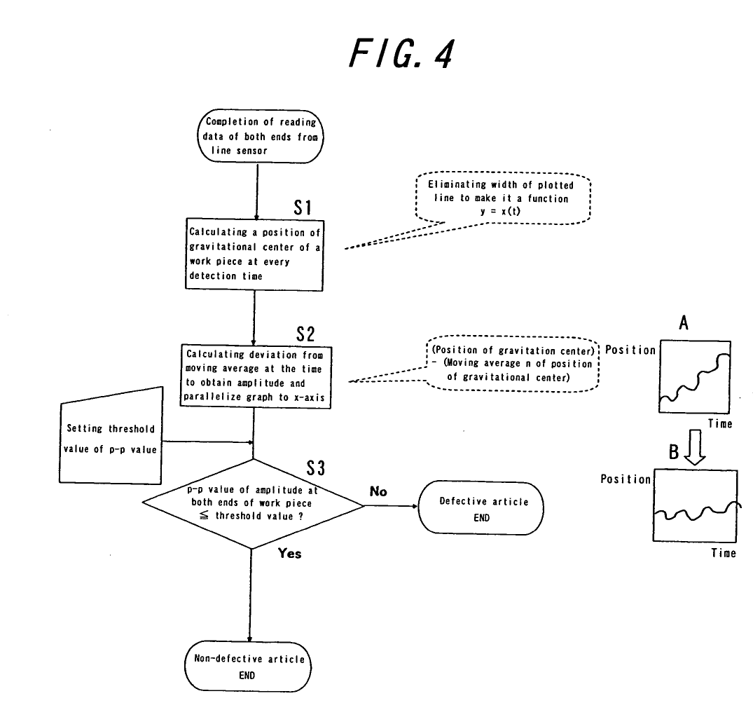

FIG. 4 is a flowchart for explaining a method of calculating a fluctuation value of the position of gravitational center from data read by and stored in the two-dimensional image reading means. With reference to FIG. 4, explanation will be made on the method of calculating a positional fluctuation value according to the present invention. Upon completion of reading a detection signal (reading a two-dimensional image) based upon shielded light during rolling down by the line sensor, a position of gravitational center (a position of gravitational center by the shielded light signal) of a work piece (a rod to be inspected) is calculated at every detection time (step S1). The position of gravitational center of the rod at a time t, is calculated by the following formula (1):

$${\sum }_{n = 1}^{7450} f t ( n ) = \frac{S}{2} \qquad ( 1 )$$

where fₜ(n) is an output voltage value detected by an n-th photoelectric transducer in the line sensor at a time t, and S is an integral value (area) of a part defined by the output voltage value fₜ(n) and the time axis (which corresponds to an area of a rectangle of a detection signal shown in FIG. 5). A position Xg(t) of gravitational center at the time t can be obtained from the formula (1).

Next, at step S2, in order to calculate an amplitude of the positional fluctuation during rolling down of the rod, a corrected position X′g(t) of gravitational center at the time t is calculated from the position Xg(t) of gravitational center at the time t. The corrected position X′g(t) of gravitational center is obtained by subjecting Xg(t) to a moving average calculation process using the following formula (2):

$${X}^{′} g ( t ) = X g ( t ) - \frac{{\sum }_{t = 1}^{h} X g ( t )}{h} \qquad ( 2 )$$

where h is a coefficient of the moving average process, and may be set to a value from 10 to 100 in this calculation process.

The position of gravitational center of the downwardly rolling rod is exhibited by a relationship between a position and a time which is schematically indicated in the graph A in FIG. 4, and as to the corrected position of gravitational center, the time axis is modified in the horizontal direction as schematically indicated in the graph B in FIG. 4.

A maximum fluctuation amplitude (a value obtained by subtracting a negative minimum peak value from a positive maximum peak value: p-p value) from data of the fluctuation value of the corrected position of gravitational center, and the thus obtained p-p value is compared with a threshold value which should exhibit a non-defective article. If the p-p value is not greater than the threshold value, the rod is determined as a non-defective article, but if the p-p value is greater than the threshold value, the rod is determined as a defective article (step S3). FIG. 8 shows a schematic (exaggerated) view for explaining a warpage of the rod.

### EXAMPLE

Several glass rods each having a diameter of 0.6 mm and a length of 500 mm were prepared. As to these rods, degrees of warpage were measured with the use of the apparatus for inspecting a warpage of a rod according to the present invention, in a condition described below. Signals of shielded light positions at opposite side end parts of the rod were simultaneously detected to obtain positional fluctuation values at the opposite side end parts of the rod. The rods were sorted depending upon a degree of a warpage. The rods having a threshold value of maximum amplitudes (p-p values) of the positional fluctuation not greater than 0.04 mm at each side end part were sorted into a group A, while the rods having a threshold value of maximum amplitudes at either of both side end parts of the rod greater than 0.04 mm were sorted into a group B.

(Detection of Shielded Light Signal)

| | | |
|---|---|---|
| Inclined angle of inspection bed: | 5 | deg. |
| Length of slit of inspection bed: | 120 | mm |
| Width of slit of inspection bed: | 5 | mm |
| Number of CCD pixels of line sensor: | 7,450 | |
| Signal detection intervals: | 0.4 | msec. |
| Total signal detection time: | 1.6 | sec. |

(Calculation of Positional Fluctuation Value)
Coefficient h of moving average process for position of gravitational center 50

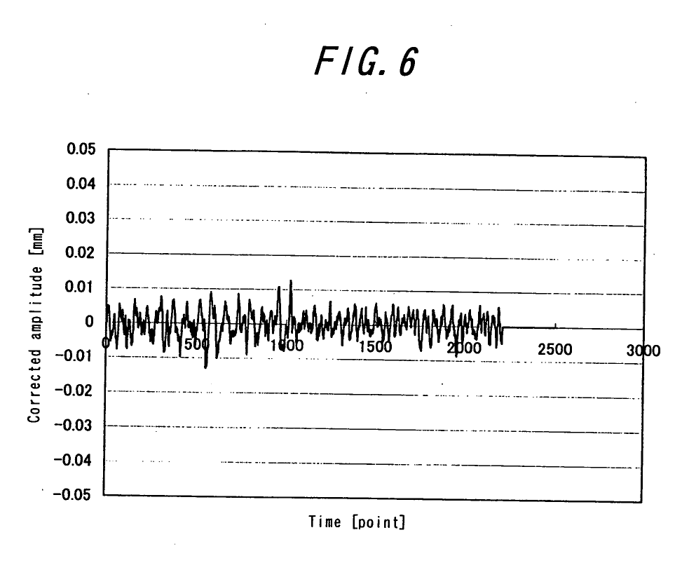

Typical data of corrected positional fluctuation obtained by the rods sorted in the group A having small warpage values is plotted in FIG. 6. It is shown that the rod rolls down while the position fluctuates back and forth in relation to the roll-down direction by about 0.01 mm during rolling down. The p-p value of this sample is about 0.02.

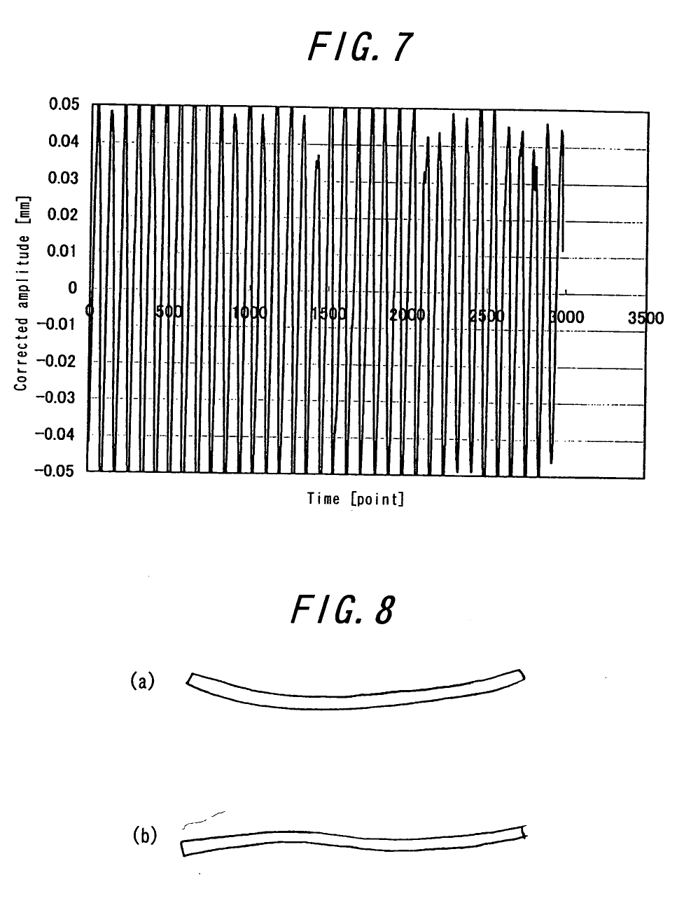

FIG. 7 shows data of corrected positional fluctuation obtained by the rods sorted into the group B having large warpage values. It is shown that the rod rolls down while the position fluctuates back and forth by about 0.05 mm in relation to the roll-down direction during rolling down. The p-p value of this sample is about 0.10. An optical image element prepared by accumulating the rods in the group A and an optical image element prepared by accumulating the rods in the group B were respectively obtained. No disturbance was found in the former optical image element but disturbance was found in the later optical image element.

The measurements of positional fluctuation of a downwardly rolling rod were made at both side end parts of the rod in the above-mentioned example with the provision of two systems each having an optical system including the illumination device and the line sensor which are required for detection of the shielded light signal, the image reading means and the positional fluctuation calculating means. However, the measurements may be made in the vicinity of one of the side end parts, and may be made at one position in the center part of the rod, or at a plurality of positions on the rod.

Specific explanation has been made on glass rod wire material in the method of inspecting a warpage of a rod according to the present invention. However, the object to be inspected in the present invention should not be limited to these rods, and a rod-like object or a linear object having a circular cross section and made of any of various materials, such as metal, resin, ceramic or carbon may be used for evaluation, measurement, inspection and sorting as to a warpage or a curve. The inspection apparatus according to the present invention is in particular useful for rapidly and conveniently inspecting and sorting products or semi-manufactured products during a manufacturing process.

Thus, according to the present invention, a rod (a linear object or a rod-like object having a circular cross-section) may be conveniently inspected in view of a degree of a warpage (curve or deformation) thereof.

1. A method of inspecting a warpage of a rod to be inspected, comprising the steps of rolling down the rod to be inspected on an inspection bed, detecting light shielded by the downwardly rolling rod by a line sensor as a one-dimensional image signal, obtaining a positional fluctuation value of the downwardly rolling rod from a two-dimensional image signal obtained from the one-dimensional image signal, and inspecting a warpage of the rod on the basis of the positional fluctuation value.

2. The method of inspecting a warpage of a rod according to claim 1, further comprising the step of obtaining a position of gravitational center of the downwardly rolling rod from the two-dimensional image, and wherein the positional fluctuation value is a fluctuation value in a corrected position of gravitational center indicated as a difference between the position of gravitational center and a moving average of the position of gravitational center.

3. The method of inspecting a warpage of a rod according to claim 1 or 2, wherein the shielded light signal is detected proximate to one end of the rod to be inspected.

4. An apparatus for inspecting a warpage of a rod, comprising an inspection bed for rolling down a rod to be inspected in an inclined direction; an illumination device arranged on one side in relation to a slit provided in the inclined direction of the inspection bed; a line sensor arranged on another side in relation to the slit; an image reading means for reading a one-dimensional image signal detected by the line sensor, as a two-dimensional image signal, in accordance with light emitted from the illumination device and shielded by the downwardly rolling rod to be inspected; and a computation means for calculating a positional fluctuation value of the downwardly rolling rod from the two dimensional image signal.

5. The apparatus for inspecting a warpage of a rod according to claim 4, wherein the computation means is configured to carry out such a computation that a position of gravitational center of the downwardly rolling rod is obtained from the two-dimensional image signal, then, a corrected position of gravitational center of the downwardly rolling rod is obtained from a difference between the position of gravitational center and a moving average of the position of gravitational center, and thereafter, a maximum amplitude of the corrected position of gravitational center is computed.

6. The apparatus for inspecting a warpage of a rod according to claim 4, further comprising a memory means for holding a threshold value for the maximum amplitude, and a determination means for determining whether the rod to be inspected is good or bad by comparing the maximum amplitude of the rod to be inspected with the threshold value.

7. The apparatus for inspecting a warpage of a rod according to any one of claims 4 or 5, wherein the slit is provided at a position proximate to one end of the downwardly rolling rod to be inspected.

8. The apparatus for inspecting a warpage of a rod according to any one of claims 4 or 5, wherein the illumination device is a linear light source in which LEDs are linearly arranged or a rod-like fluorescent lamp.
